(19) United States
(12) Patent Application Publication
(10) Pub. No.: US 2010/0031203 A1
(43) Pub. Date: Feb. 4, 2010

(54) USER-DEFINED GESTURE SET FOR SURFACE COMPUTING

(75) Inventors: Meredith J. Morris, Bellevue, WA (US); Jacob O. Wobbrock, Seattle, WA (US); Andrew David Wilson, Seattle, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/490,335

(22) Filed: Jun. 24, 2009

Related U.S. Application Data
(63) Continuation of application No. 12/185,166, filed on Aug. 4, 2008.

(51) Int. Cl. G06F 3/033; G09G 5/00

(52) U.S. Cl. 715/863; 345/156

(57) ABSTRACT

The claimed subject matter provides a system and/or a method that facilitates generating an intuitive set of gestures for employment with surface computing. A gesture set creator can prompt two or more users with a potential effect for a portion of displayed data. An interface component can receive at least one surface input from the user in response to the prompted potential effect. A surface detection component can track the surface input utilizing a computer vision-based sensing technique. The gesture set creator collects the surface input from the two or more users in order to identify a user-defined gesture based upon a correlation between the respective surface inputs, wherein the user-defined gesture is defined as an input that initiates the potential effect for the portion of displayed data.

### CROSS REFERENCE TO RELATED APPLICATION(S)

This application is a continuation of U.S. patent application Ser. No. 12/185,166, filed on Aug. 4, 2008, entitled “A USER-DEFINED GESTURE SET FOR SURFACE COMPUTING”, the entire disclosure of which is hereby incorporated by reference. This application relates to U.S. patent application Ser. No. 12/118,955 filed on May 12, 2008, entitled “COMPUTER VISION-BASED MULTI-TOUCH SENSING USING INFRARED LASERS” and U.S. patent application Ser. No. 12/185,174 filed on Aug. 4, 2008, entitled “FUSING RFID AND VISION FOR SURFACE OBJECT TRACKING”, the entire disclosure of each of which are hereby incorporated by reference.

### BACKGROUND

Computing devices are increasing in technological ability wherein such devices can provide a plurality of functionality within a limited device-space. Computing devices can be, but not limited to, mobile communication devices, desktop computers, laptops, cell phones, PDA, pagers, tablets, messenger devices, hand-helds, pocket translators, bar code scanners, smart phones, scanners, portable handheld scanners, and any other computing device that allows data interaction. Although each device employs a specific function for a user, devices have been developing to allow overlapping functionality in order to appeal to consumer needs. In other words, computing devices have incorporated a plurality of features and/or applications such that the devices have invaded one another's functionality. For example, cell phones can provide cellular service, phonebooks, calendars, games, voicemail, paging, web browsing, video capture, image capture, voice memos, voice recognition, high-end mobile phones (e.g., smartphones becoming increasingly similar to portable computers/laptops in features and functionality), etc.

As a result, personal computing devices have incorporated a variety of techniques and/or methods for inputting information. Personal computing devices facilitate entering information employing devices such as, but not limited to, keyboards, keypads, touch pads, touch-screens, speakers, stylus' (e.g., wands), writing pads, etc. However, input devices such as keypads, speakers and writing pads bring forth user personalization deficiencies in which each user can not utilize the data entry technique (e.g., voice, and/or writing) similarly. For example, consumers employing writing recognition in the United States can write in English, yet have distinct and/or different letter variations.

Furthermore, computing devices can be utilized for data communications or data interactions via such above-described techniques. A particular technique growing within computing devices is interactive surfaces or related tangible user interfaces, often referred to as surface computing. Surface computing enables a user to physically interact with displayed data as well as physical objects detected in order to provide a more intuitive data interaction. For example, a photograph can be detected and annotated with digital data, wherein a user can manipulate or interact with such real photograph and/or the annotation data. Thus, such input techniques allow for objects to be identified, tracked, and augmented with digital information. Moreover, users may not find conventional data interaction techniques or gestures intuitive for most surface computing systems. For instance, many surface computing systems employ gestures created by system designers which are not reflective of a typical user's behavior. In other words, typical gestures for data interaction for surface computing systems are unintuitive and rigid which do not take into account of a non-technical user's perspective.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate collecting surface input data in order to generate a user-defined gesture set. A gesture set creator can evaluate surface inputs from users in response to data effects, wherein the gesture set creator can generate a user-defined gesture based upon surface inputs between two or more users. In particular, a group of users can be prompted with an effect on displayed data and responses can be tracked in order to identify a user-defined gesture for such effect. For example, the effect can be one of a data selection, a data set selection, a group selection, a data move, a data pan, a data rotate, a data cut, a data paste, a data duplicate, a data delete, an accept, a help request, a reject, a menu request, an undo, a data enlarge, a data shrink, a zoom in, a zoom out, an open, a minimize, a next, or a previous. In other aspects of the claimed subject matter, methods are provided that facilitates identifying a gesture set from two or more users for implementation with surface computing.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates collecting surface input data in order to generate a user-defined gesture set.

FIG. 2 illustrates a block diagram of an exemplary system that facilitates identifying a gesture set from two or more users for implementation with surface computing.

FIG. 3 illustrates a block diagram of an exemplary system that facilitates identifying a user-defined gesture and providing explanation on use of such gesture.

FIG. 4 illustrates a block diagram of exemplary gestures that facilitates interacting with a portion of displayed data.

FIG. 5 illustrates a block diagram of exemplary gestures that facilitates interacting with a portion of displayed data.

FIG. 6 illustrates a block diagram of an exemplary system that facilitates automatically identifies correlations between various surface inputs from disparate users in order to create a user-defined gesture set.

FIG. 7 illustrates an exemplary methodology for collecting surface input data in order to generate a user-defined gesture set.

FIG. 8 illustrates an exemplary methodology that facilitates creating and utilizing a user-defined gesture set in connection with surface computing.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “creator,” “evaluator,” “prompter” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

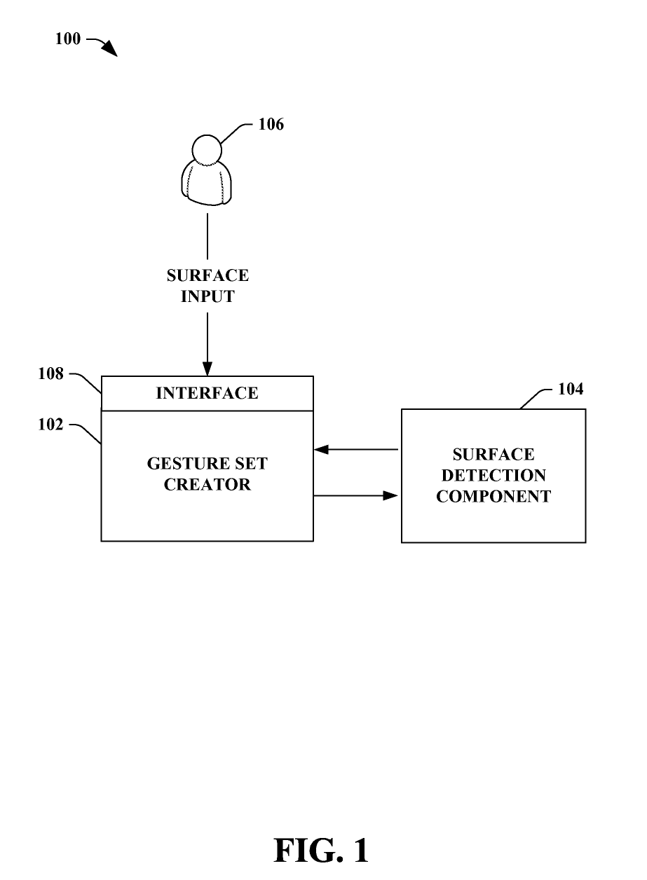

Now turning to the figures, FIG. 1 illustrates a system 100 that facilitates collecting surface input data in order to generate a user-defined gesture set. The system 100 can include a gesture set creator 102 that can aggregate surface input data from a user 106 in order to identify a user-defined gesture for implementation with a surface detection component 104. In particular, the user 106 can provide a surface input or a plurality of surface inputs via an interface component 108 in response to, for instance, a prompted effect associated with displayed data. Such surface inputs can be collected and analyzed by the gesture set creator 102 in order to identify a user-defined gesture for the prompted effect, wherein two or more user-defined gestures can be a user-defined gesture set. The gesture set creator 102 can prompt or provide the user 106 with a potential effect for displayed data in which the user 106 can provide his or her response via surface inputs. Such surface input response can be indicative of the user 106 intuitive response on how to implement the potential effect via surface inputs for displayed data. Moreover, the surface detection component 104 that can detect a surface input from at least one of a user, a corporeal object, or any suitable combination thereof. Upon detection of such surface input, the surface detection component 104 can ascertain a position or location for such surface input.

The surface detection component 104 can be utilized to capture touch events, surface inputs, and/or surface contacts. It is to be appreciated that such captured or detected events, inputs, or contacts can be gestures, hand-motions, hand interactions, object interactions, and/or any other suitable interaction with a portion of data. For example, a hand interaction can be translated into corresponding data interactions on a display. In another example, a user can physically interact with a cube physically present and detected, wherein such interaction can allow manipulation of such cube in the real world as well as data displayed or associated with such detected cube. It is to be appreciated that the surface detection component 104 can utilize any suitable sensing technique (e.g., vision-based, non-vision based, etc.). For instance, the surface detection component 104 can provide capacitive sensing, multi-touch sensing, etc.

For example, a prompted effect of deleting a portion of displayed object can be provided to the user, wherein the user can provide his or her response via surface inputs. Based on evaluation of two or more users and respective surface inputs, a user-defined gesture can be identified for deleting a portion of displayed data. In other words, the prompted effect and collected results enables a user-defined gesture set to be generated based upon evaluation of user inputs.

It is to be appreciated that the prompted effect can be communicated to the user in any suitable manner and can be, but is not limited to being, a portion of audio, a portion of video, a portion of text, a portion of a graphic, etc. For instance, a prompted effect can be shown to a user via a verbal instruction. Moreover, it is to be appreciated that the gesture set creator 102 can monitor, track, record, etc. responses from the user 106 in addition to surface input response. For example, the user 106 can be video taped in order to evaluate confidence in responses by examining verbal responses, facial expressions, physical demeanor, etc.

In addition, the system 100 can include any suitable and/or necessary interface component 108 (herein referred to as “interface 108”), which provides various adapters, connectors, channels, communication paths, etc. to integrate the gesture set creator 102 into virtually any operating and/or database system(s) and/or with one another. In addition, the interface 108 can provide various adapters, connectors, channels, communication paths, etc., that provide for interaction with the gesture set creator 102, the surface detection component 104, the user 106, surface inputs, and any other device and/or component associated with the system 100.

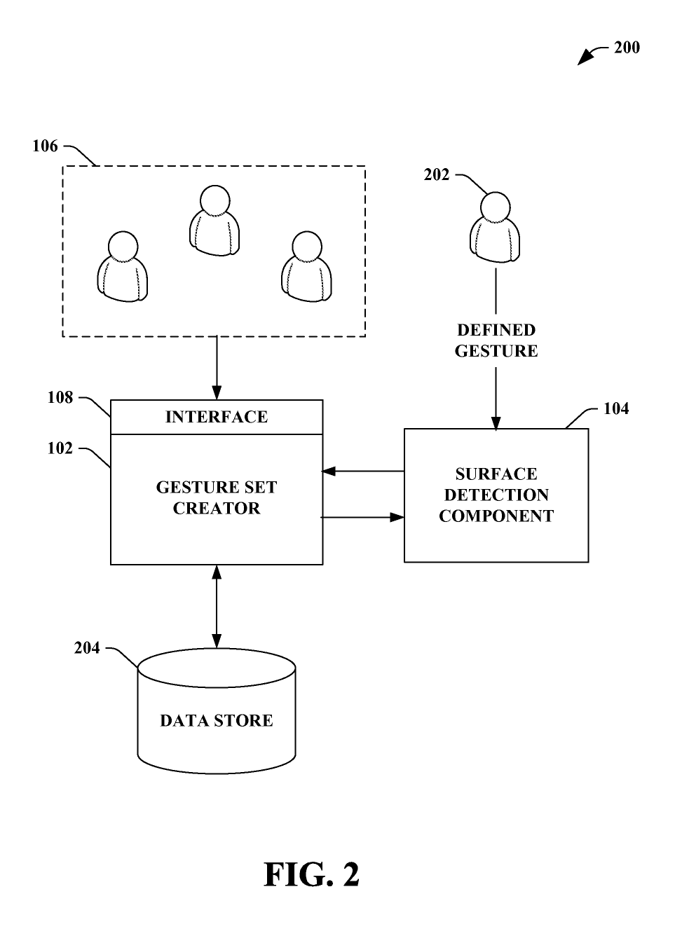

FIG. 2 illustrates a system 200 that facilitates identifying a gesture set from two or more users for implementation with surface computing. The system 200 can include the gesture set creator 102 that can collect and analyze surface inputs (received by the interface 108 and tracked by the surface detection component 104) from two or more users 106 in order to extract a user-defined gesture set that is reflective of the consensus for a potential effect for displayed data. Upon identification of two or more user-defined gestures, such gestures can be referred to as a user-defined gesture set. Once defined, the surface detection component 104 (e.g., computer vision-based activity sensing, surface computing, etc.) can detect at least one user-defined gesture and initiate the effect to which the gesture is assigned or linked.

It is to be appreciated that any suitable effect for displayed data can be presented to the users 106 in order to identify a user-defined gesture. For example, the effect can be, but is not limited to, data selection, data set or group selection, data move, data pan, data rotate, data cut, data paste, data duplicate, data delete, accept, help, reject, menu, undo, data enlarge, data shrink, zoom in, zoom out, open, minimize, next, previous, etc. Moreover, the user-defined gestures can be implemented by any suitable hand gesture or portion of the hand (e.g., entire hand, palm, one finger, two fingers, etc.).

The system 200 can further include a data store 204 that can store various data related to the system 200. For instance, the data store 204 can include any suitable data related to the gesture set creator 102, the surface detection component 104, two or more users 106, the interface 108, the user 202, etc. For example, the data store 204 can store data such as, but not limited to, a user-defined gesture, a user-defined gesture set, collected surface inputs corresponding to a prompted effect, effects for displayed data, prompt techniques (e.g., audio, video, verbal, etc.), tutorial data, correlation data, surface input collection techniques, surface computing data, surface detection techniques, user preferences, user data, etc.

The data store 204 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 204 of the subject systems and methods is intended to comprise, without being limited to, these and any other suitable types of memory and/or storage. In addition, it is to be appreciated that the data store 204 can be a server, a database, a relational database, a hard drive, a pen drive, and the like.

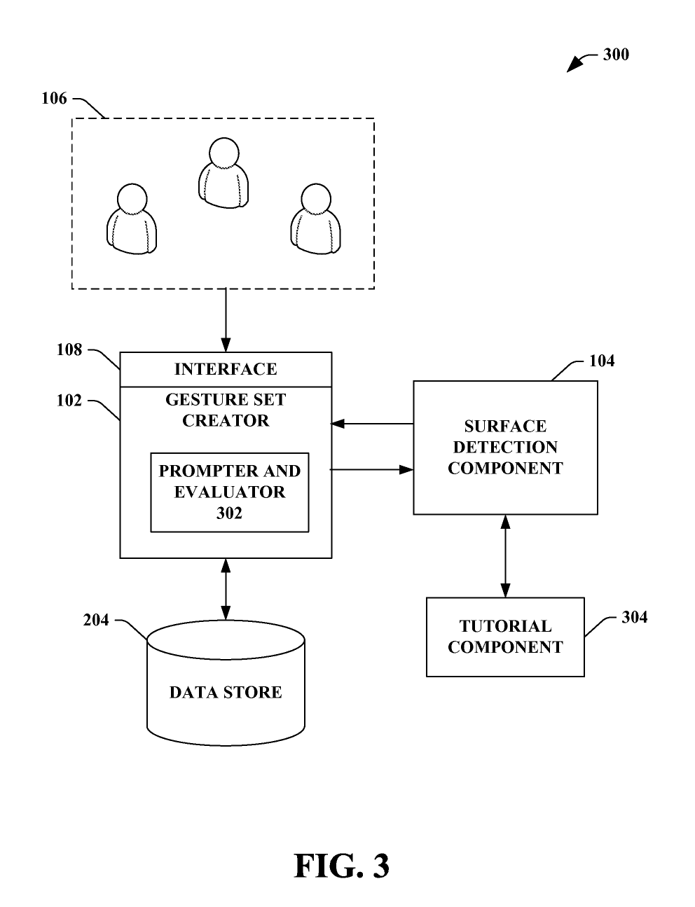

FIG. 3 illustrates a system 300 that facilitates identifying a user-defined gesture and providing explanation on use of such gesture. The system 300 can include the gesture set creator 102 that can receive experimental surface data or surface inputs from a plurality of users 106 in order to generate a user-defined gesture set based on correlations associated with such received data. It is to be appreciated that the user-defined gesture and/or the user-defined gesture set can be utilized in connection with surface computing technologies (e.g., tabletops, interactive tabletops, interactive user interfaces, surface detection component 104, surface detection systems, etc.).

The system 300 can further include a prompter and evaluator 302. The prompter and evaluator 302 can provide at least one of the following: a prompt related to a potential effect on displayed data; or an evaluation of aggregated test surface input data (e.g., surface inputs in response to a prompted effect which are in a test or experiment stage). The prompter and evaluator 302 can communicate any suitable portion of data to at least one user 106 in order to generate a response via the surface detection component 104 and/or the interface 108. In particular, the prompt can be a communication of a potential effect a potential gesture may have on displayed data. Moreover, it is to be appreciated that the prompt can be a portion of audio, a portion of video, a portion of a graphic, a portion of text, a portion of verbal instructions, etc. Furthermore, the prompter and evaluator 302 can provide comparative analysis and/or agreement calculations (e.g., discussed in more detail below) in order to identify similar surface inputs from users 106 which can be reflective of a user-defined gesture (e.g., users providing similar surface inputs in response to a potential effect can be identified as a user-defined gesture). Additionally, it is to be appreciated that the prompter and evaluator 302 can analyze any suitable data collected from the prompted effect such as, but not limited to, surface inputs, user reactions, verbal responses, etc.

The system 300 can further include a tutorial component 304 that can provide a portion of instructions in order to inform or educate a user to the generated user-defined gesture set. For example, the tutorial component 304 can provide a portion of audio, a portion of video, a portion of a graphic, a portion of text, etc. in order to inform a user of at least one user-defined gesture created by the gesture set creator 102. For example, a tutorial can be a brief video that provides examples on gestures and effects of such gestures on displayed data.

Many surface computing prototypes have employed gestures created by system designers. Although such gestures are appropriate for early investigations, they are not necessarily reflective of user behavior. The subject innovation provides an approach to designing tabletop gestures that relies on eliciting gestures from non-technical users by first portraying the effect of a gesture, and then asking users to perform its cause. In all, 1080 gestures from 20 participants were logged, analyzed, and paired with think-aloud data for 27 commands performed with 1 and/or 2 hands. The claimed subject matter can provide findings that indicate that users rarely care about the number of fingers they employ, that one hand is preferred to two, that desktop idioms strongly influence users' mental models, and that some commands elicit little gestural agreement, suggesting the need for on-screen widgets. The subject innovation further provides a complete user-defined gesture set, quantitative agreement scores, implications for surface technology, and a taxonomy of surface gestures.

To investigate these idiosyncrasies, a guessability study methodology is employed that presents the effects of gestures to participants and elicits the causes meant to invoke them. For example, by using a think-aloud protocol and video analysis, rich qualitative data can be obtained that illuminates users' mental models. By using custom software with detailed logging on a surface computing system/component, quantitative measures can be obtained regarding gesture timing, activity, and/or preferences. The result is a detailed picture of user-defined gestures and the mental models and performance that accompany them. The principled approach implemented by the subject innovation in regards to gesture definition is the first to employ users, rather than principles, in the development of a gesture set. Moreover, non-technical users without prior experience with touch screen devices were explicitly recruited, expecting that such users would behave with and reason about interactive tabletops differently than designers and system builders.

The subject innovation contributes the following to surface computing: (1) a quantitative and qualitative characterization of user-defined surface gestures, including a taxonomy, (2) a user-defined gesture set, (3) insight into users' mental models when making surface gestures, and (4) an understanding of implications for surface computing technology and user interface design. User-centered design can be a cornerstone of human-computer interaction. But users are not designers; therefore, care can be taken to elicit user behavior profitable for design.

A human's use of an interactive computer system comprises a user-computer dialogue, a conversation mediated by a language of inputs and outputs. As in any dialogue, feedback is essential to conducting this conversation. When something is misunderstood between humans, it may be rephrased. The same is true for user-computer dialogues. Feedback, or lack thereof, either endorses or deters a user's action, causing the user to revise his or her mental model and possibly take a new action.

In developing a user-defined gesture set for surface computing, the vicissitudes of gesture recognition to influence users' behavior was limited for its influence. Put another way, the gulf of execution was removed from the dialogue, creating, in essence, a “monologue” environment in which the user's behavior is acceptable. This enables users' uncorrected behavior to be observed and drive system design to accommodate it. Another reason for examining users' uncorrected behavior is that interactive tabletops (e.g., surface detection systems, surface computing, etc.) may be used in public spaces, where the importance of immediate usability is high.

A user-defined gesture set can be generated by the subject innovation. A particular gesture set was created by having 20 non-technical participants perform gestures with a surface computing system (e.g., interactive tabletop, interactive interface, etc.). To avoid bias, no elements specific to a particular operating system were utilized or shown. Similarly, no specific application domain was assumed. Instead, participants acted in a simple blocks world of 2D shapes. Each participant saw the effect of a gesture (e.g., an object moving across the table or surface) and was asked to perform the gesture he or she thought would cause that effect (e.g., holding the object with the left index finger while tapping the destination with the right). In linguistic terms, the effect of a gesture is the referent to which the gestural sign refers. Twenty-seven referents were presented, and gestures were elicited for 1 and 2 hands. The system 300 tracked and logged hand contact with the table. Participants used the think-aloud protocol and were videotaped and supplied subjective preferences.

The final user-defined gesture set was developed in light of the agreement or correlation participants exhibited in choosing gestures for each command. The more participants that used the same gesture for a given command, the more likely that gesture would be assigned to that command. In the end, the user-defined gesture set emerged as a surprisingly consistent collection founded on actual user behavior.

The subject innovation presented the effects of 27 commands (e.g., referents) to 20 participants or users, and then asked them to choose a corresponding gesture (e.g., sign). The commands were application-agnostic, obtained from existing desktop and tabletop systems. Some were conceptually straightforward, others more complex. Each referent's conceptual complexity was rated before participants made gestures.

It is to be appreciated that any suitable number of users can be utilized to create a gesture set. Moreover, each user can have various characteristics or qualities. For example, twenty paid participants can be used in which eleven were male, 9 female, having an average age was 43.2 years (sd=15.6). The participants were recruited from the general public and were not computer scientists or user interface designers.

The generation of the user-defined gesture set can be implemented on the surface detection component 104 and/or any other suitable surface computing system (e.g., interactive tabletop, interactive interface, surface vision system, etc.). For example, an application can be utilized to present recorded animations and speech illustrating 27 referents to the user, yet it is to be appreciated that any suitable number of referents can be utilized with the subject innovation. For example, for the pan referent, a recording can say, “Pan. Pretend you are moving the view of the screen to reveal hidden off-screen content. Here's an example.” After the recording finished, software animated a field of objects moving from left to right. After the animation, the software showed the objects as they were before the panning effect, and waited for the user to perform a gesture.

The system 300 can monitor participants' hands from beneath the table or surface and report contact information. Contacts and/or surface inputs can be logged as ovals having millisecond timestamps. These logs were then parsed to compute trial-level measures. Participants' hands can also be videotaped from, for example, four angles. In addition, a user observed each session and took detailed notes, particularly concerning the think-aloud data.

The system 300 randomly presented 27 referents to participants. For each referent, participants performed a 1-hand and a 2-hand gesture while thinking aloud. After each gesture, participants were shown two 7-point Likert scales. After performing 1- and 2-hand gestures for a referent, participants were also asked which number of hands they preferred. With 20 participants, 27 referents, and 1 and 2 hands, a total of 20×27×2=1080 gestures were made. Of these, 6 can be discarded due to participant confusion.

The subject innovation can establish a versatile taxonomy of surface gestures based on users' behavior. In working through collected data, the system 300 can iteratively develop such a taxonomy to help capture the design space of surface gestures. Authors or users can manually classify each gesture along four dimensions: form, nature, binding, and flow. Within each dimension are multiple categories, shown in Table 1 below.

TABLE 1
TAXONOMY OF SURFACE GESTURES

| | | |
|---|---|---|
| Form | static pose | Hand pose is held in one location. |
| | dynamic pose | Hand pose changes in one |
| | | location. |
| | static pose and | Hand pose is held as hand moves. |
| | path | |
| | dynamic pose and | Hand pose changes as hand |
| | path | moves. |
| | one-point touch | Static pose with one finger. |
| | one-point path | Static pose & path with one |
| | | finger. |
| Nature | symbolic | Gesture visually depicts a symbol. |
| | physical | Gesture acts physically on |
| | | objects. |
| | metaphorical | Gesture indicates a metaphor. |
| | abstract | Gesture-referent mapping is |
| | | arbitrary. |
| Binding | object-centric | Location defined w.r.t. object |
| | | features. |
| | world-dependent | Location defined w.r.t. world |
| | | features. |
| | world-independent | Location can ignore world |
| | | features. |
| | mixed | World-independent plus another. |
| | dependencies | |
| Flow | discrete | Response occurs after the user |
| | | acts. |
| | continuous | Response occurs while the user |
| | | acts. |

The scope of the form dimension is within one hand. It is applied separately to each hand in a 2-hand gesture. One-point touch and one-point path are special cases of static pose and static pose and path, respectively. These are distinguishable because of their similarity to mouse actions. A gesture is still considered a one-point touch or path even if the user casually touches with more than one finger at the same point, as participants often did. Such cases investigated during debriefing, finding that users' mental models of the gesture required only one point.

In the nature dimension, symbolic gestures can be visual depictions. Examples are tracing a caret (“̂”) to perform insert, or forming the O.K. pose on the table (“ [symbol] ”) for accept. Physical gestures can ostensibly have the same effect on a table with physical objects. Metaphorical gestures can occur when a gesture acts on, with, or like something else. Examples are tracing a finger in a circle to simulate a “scroll ring,” using two fingers to “walk” across the screen, pretending the hand is a magnifying glass, swiping as if to turn a book page, or just tapping an imaginary button. The gesture itself may not be enough to reveal its metaphorical nature; the answer lies in the user's mental model.

In the binding dimension, object-centric gestures require information about the object(s) they affect or produce. An example is pinching two fingers together on top of an object for shrink. World-dependent gestures are defined with respect to the world, such as tapping in the top-right corner of the display or dragging an object off-screen. World-independent gestures require no information about the world, and generally can occur anywhere. This category can include gestures that can occur anywhere except on temporary objects that are not world features. Finally, mixed dependencies occur for gestures that are world-independent in one respect but world-dependent or object-centric in another. This sometimes occurs for 2-hand gestures, where one hand acts on an object and the other hand acts anywhere.

A gesture's flow can be discrete if the gesture is performed, delimited, recognized, and responded to as an event. An example is tracing a question mark (“?”) to bring up help. Flow is continuous if ongoing recognition is required, such as during most of participants' resize gestures.

The subject innovation can create a user-defined gesture set. Discussed below is the process by which the set was created and properties of the set. Unlike prior gesture sets for surface computing, this set is based on observed user behavior and links gestures to commands. After all 20 participants (e.g., any suitable number of participants can be utilized) had provided gestures for each referent for one and two hands, the gestures within each referent were clustered such that each cluster held matching gestures. It is to be appreciated that any suitable agreement or correlation can be implemented by the system 300 (e.g., prompter and evaluator 302, gesture set creator 102, etc.). Cluster size was then used to compute an agreement score A that reflects, in a single number, the degree of consensus among participants:

$$A = \frac{{\sum }_{r ∈ R} {\sum }_{{P}_{i} ⊆ {P}_{r}} {( \frac{\vert {P}_{i} \vert}{\vert {P}_{r} \vert} )}^{2}}{\vert R \vert} \qquad ( 1 )$$

In Eq. 1, r is a referent in the set of all referents R, Pᵣ is the set of proposed gestures for referent r, and Pᵢ is a subset of identical gestures from Pᵣ. The range for A is [|Pᵣ|⁻¹, 1]. As an example, consider the agreement scores for move a little (2-hand) and select single (1-hand). Both can have four clusters. The former had clusters of sizes 12, 3, 3, and 2; the latter of sizes 11, 3, 3, and 3. For move a little, the below is computed:

$${A}_{move} = {( \frac{12}{20} )}^{2} + {( \frac{3}{20} )}^{2} + {( \frac{3}{20} )}^{2} + {( \frac{2}{20} )}^{2} = 0.415 \qquad ( 2 )$$

For select single, the below is computed:

$${A}_{select} = {( \frac{11}{20} )}^{2} + {( \frac{3}{20} )}^{2} + {( \frac{3}{20} )}^{2} + {( \frac{3}{20} )}^{2} = 0.370 \qquad ( 3 )$$

The overall agreement for 1- and 2-hand gestures was A_{1H}=0.323 and A_{2H}=0.285, respectively.

In general, the user-defined gesture set was developed by taking the large clusters for each referent and assigning those clusters' gestures to the referent. However, where the same gesture was used to perform two different commands, a conflict occurs. In this case, the largest cluster wins. The resulting user-defined gesture set generated and provided by the subject innovation is conflict-free and covers 57.0% of all gestures proposed.

Aliasing has been shown to dramatically increase the guessability of input. In the user-defined set, 10 referents are assigned 1 gesture, 4 referents have 2 gestures, 3 referents have 3 gestures, 4 referents have 4 gestures, and 1 referent has 5 gestures. There are 48 gestures in the final set. Of these, 31 (64.6%) are performed with one hand, and 17 (35.4%) are performed with two.

Satisfyingly, a high degree of consistency and parallelism exists in our user-defined set. Dichotomous referents use reversible gestures, and the same gestures are reused for similar operations. For example, enlarge, which can be accomplished with 4 distinct gestures, is performed on an object, but the same 4 gestures can be used for zoom in if performed in the background, or for open if performed on a container (e.g., a folder). In addition, flexibility is allowed: the number of fingers rarely matters and the fingers, palms, or edges of the hands can often be used to the same effect.

Perhaps not surprisingly, referents' conceptual complexities correlated significantly with gesture planning time (R²=0.51, F_{1,25}=26.04, p<0.0001), as measured by the time between the end of a referent's A/V prompt and the participant's first contact with the surface. In general, the more complex the referent, the more time participants took to begin articulating their gesture. Simple referents took about 8 seconds of planning. Complex referents took about 15 seconds. Conceptual complexity did not, however, correlate significantly with gesture articulation time.

After performing each gesture, participants can rate it on two Likert scales. The first read, “The gesture I picked is a good match for its intended purpose.” The second read, “The gesture I picked is easy to perform.” Both scales solicited ordinal responses from 1=strongly disagree to 7=strongly agree.

Gestures that were members of larger clusters for a given referent had significantly higher goodness ratings (χ²=42.34, df=1, p<0.0001), indicating that popularity does, in fact, identify better gestures over worse ones. This finding goes a long way to validating the assumptions underlying this approach to gesture design.

Referents' conceptual complexity significantly affected participants' feelings about the goodness of their gestures (χ²=19.92, df=1, p<0.0001). The simpler referents were rated about 5.6, while the more complex were rated about 4.9, suggesting complex referents elicited gestures about which participants felt less confident.

Planning time also significantly affected participants' feelings about the goodness of their gestures (χ²=33.68, df=1, p<0.0001). Generally, as planning time decreased, goodness ratings increased, suggesting that good gestures were more readily apparent to participants.

Unlike planning time, articulation time did not significantly affect participants' goodness ratings, but it did affect their perception of ease (χ²=4.38, df=1, p<0.05). Gestures that took longer to perform were rated as easier, perhaps because they were smoother or less hasty. Gestures rated as difficult took about 1.5 seconds, while those rated as easy took about 3.7 seconds.

The number of touch events in a gesture significantly affected its perception of ease (χ²=24.11, df=1, p<0.0001). Gestures with the least touch activity were rated as either the hardest (e.g., 1) or the easiest (e.g., 7). Gestures with more activity were rated in the medium ranges of ease.

Overall, participants preferred 1-hand gestures for 25 referents, and were evenly divided for the other two. No referents elicited gestures for which two hands were preferred overall. The referents that elicited equal preference for 1- and 2-hands were insert and maximize, which were not included in the user-defined gesture set because they reused existing gestures.

As noted above, the user-designed set has 31 (64.6%) 1-hand gestures and 17 (35.4%) 2-hand gestures. Although participants' preference for 1-hand gestures was clear, some 2-hand gestures had good agreement scores and nicely complemented the 1-hand versions.

Examples of dichotomous referents are shrink/enlarge, previous/next, zoom in/zoom out, and so on. People generally employed reversible gestures for dichotomous referents, even though the study software rarely presented these referents in sequence. This behavior is reflected in the final user-designed gesture set, where dichotomous referents use reversible gestures.

The rank order of referents according to conceptual complexity and the order of referents according to descending 1-hand agreement may not be the same. Thus, participants and the authors did not always regard the same referents as complex. Participants often made simplifying assumptions. One participant, upon being prompted to zoom in, said, “Oh, that's the same as enlarge.” Similar mental models emerged for enlarge and maximize, shrink and minimize, and pan and move. This allows us to unify the gesture set and disambiguate the effects of gestures based on where they occur, e.g., whether they are on objects or on the background.

In general, it seemed that touches with 1-3 fingers were usually considered a “single point,” and 5 fingers or the whole palm were intentionally more. Four fingers, on the other hand, constituted a “gray area,” where it was mixed whether the number of fingers mattered. These findings are pertinent given that prior tabletop systems that have differentiated gestures based on number of fingers.

Multiple people conceived of a world beyond the edges of the table's projected screen. For example, they dragged from off-screen locations onto the screen, treating it as the clipboard. They also dragged to the off-screen areas as a place of no return for delete and reject. One participant conceived of different off-screen areas that meant different things: dragging off the top was delete, and dragging off the left was cut. For paste, she made sure to drag in from the left side, purposely trying to associate paste and cut. It is to be appreciated that such gestures (e.g., off-screen, clipboard replication gestures, etc.) can be employed by the system 300.

The subject innovation removed the dialogue between user and system to gain insight into users' “natural” behavior without the inevitable bias and behavior change that comes from recognition performance and technical limitations. In one example, the user-defined gesture set can be validated.

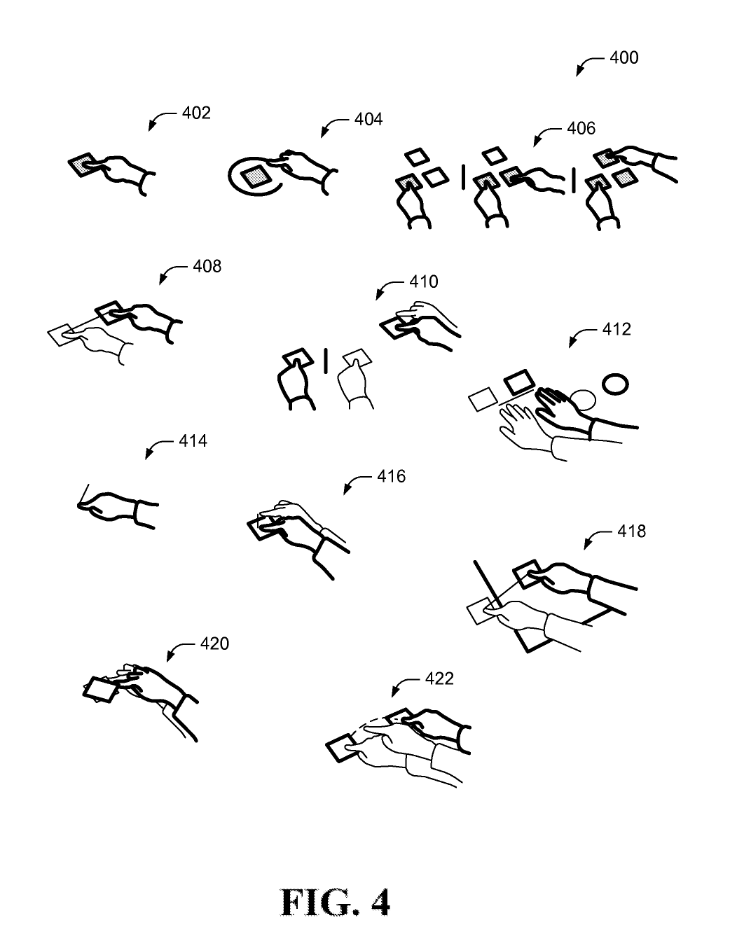

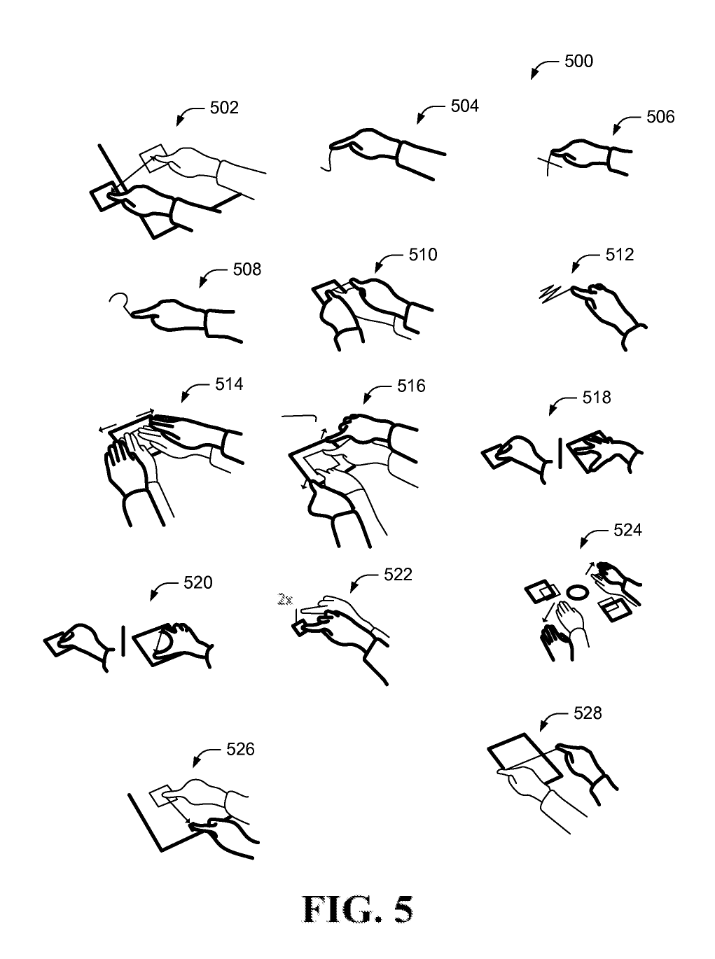

Turning to FIG. 4 and FIG. 5, FIG. 4 illustrates a gesture set 400 and FIG. 5 illustrates a gesture set 500. The gesture set 400 and the gesture set 500 facilitate interacting with a portion of displayed data. It is to be appreciated that the potential effect can be referred to as the referent. The gesture set 400 in FIG. 4 can include a first select single gesture 402, a second select single gesture 404, a select group gesture 406, a first move gesture 408, a second move gesture 410, a pan gesture 412, a cut gesture 414, a first paste gesture 416, a second paste gesture 418, a rotate gesture 420, and a duplicate gesture 422. The gesture set 500 in FIG. 5 can include a delete gesture 502, an accept gesture 504, a reject gesture 506, a help gesture 508, a menu gesture 510, an undo gesture 512, a first enlarge/shrink gesture 514, a second enlarge/shrink gesture 516, a third enlarge/shrink gesture 518, a fourth enlarge/shrink gesture 520, an open gesture 522, a zoom in/out gesture 524, a minimize gesture 526, and a next/previous gesture 528.

The below table (Table 2) described further the referent, potential effect, and/or the user-defined gesture

TABLE 2

| Referent | Gesture Description | Hands |
|---|---|---|
| Accept | Use 1-3 fingers to draw a check mark on the | 1 |
| | background | |
| Cut | Use 1-3 fingers to draw a diagonal slash (or | 1 |
| | backslash) on background (this can cut the currently | |
| | select object(s)) | |
| Delete | Move target object to off-screen destination (by | 1 |
| | dragging) | |
| Delete | Move target object to off-screen destination (by | 2 |
| | jumping) | |
| Duplicate | Use 1-3 fingers to tap object (toggles selection state) | 1 |
| | then use 1-3 fingers to tap destination on | |
| | background | |
| Enlarge | Use all five fingers on top of object, close together, | 1 |
| | and spread them out radially | |
| Enlarge | Use thumb + index finger, on top of object, close | 1 |
| | together, and spread them apart | |
| Enlarge | Use 1-3 fingers from each hand, together on the | 2 |
| | object, and move each of the two sets of fingers in | |
| | opposite directions | |
| Enlarge | Use entire hands (palms, all 5 fingers, or edges), on | 2 |
| | object, close together, and move the two hands in | |
| | opposite directions | |
| Help | Use 1-3 fingers to draw a question mark on the | 1 |
| | background (no dot needed) | |
| Menu | Use 1-3 fingers from each hand to hold object, then | 2 |
| Access | drag finger(s) from one hand out of the object while | |
| | still holding object with other finger(s) | |
| Minimize | Move target object to bottom edge of screen (edge | 2 |
| | closest to user's seat, or global bottom depending on | |
| | app) (by jumping) | |
| Minimize | Move target object to bottom edge of screen (edge | 1 |
| | closest to user's seat, or global bottom depending on | |
| | app) (by dragging) | |
| Move | Use 1-3 fingers, on object, dragging to destination | 1 |
| Move | Use 1-3 fingers to hold object, while using 1-3 | 2 |
| | fingers to tap a destination on the background | |
| Next | Use 1-3 fingers to draw a line from left to right (can | 1 |
| | start and end on background and pass through target | |
| | object, unless target object is maximized) | |
| Open | Use 1-3 fingers to double-tap object | 1 |
| Open | Enlarge “openable” object that is in a closed state | 2 |
| | (pull apart with hands) | |
| Open | Enlarge “openable” object that is in a closed state | 2 |
| | (spread apart with fingers) | |
| Open | Enlarge “openable” object that is in a closed state | 1 |
| | (reverse pinch) | |
| Open | Enlarge “openable” object that is in a closed state | 1 |
| | (splay) | |
| Pan | Use entire hand (palm or all 5 fingers) on | 1 |
| | background and drag | |
| Paste | Move beginning off-screen (jump) | 2 |
| Paste | Move beginning off-screen (drag) | 1 |
| Paste | Use 1-3 fingers to tap on the background (as long | 1 |
| | as no objects are currently in the selected state) | |
| Previous | Use 1-3 fingers to draw a line from right to left on | 1 |
| | the background (can start and end on background | |
| | and pass through target object, unless target object | |
| | is maximized) | |
| Reject | Use 1-3 fingers to draw an “X” on the background | 1 |
| | (as long as no objects are currently in the | |
| | selected state) | |
| Reject | Delete the visible dialogue/object that is being | 2 |
| | rejected (with jump) | |
| Reject | Delete the visible dialogue/object that is being | 1 |
| | rejected (with drag) | |
| Rotate | Use 1-3 fingers to hold the corner of an object and | 1 |
| | drag it (with an arc-ing motion) | |
| Select | Use 1-3 fingers to tap object(s) | 1 |
| Select | Use 1-3 fingers to draw a lasso around the object(s) | 1 |
| Select | Select all of the objects in the group (by lasso) | 1 |
| Group | | |
| Select | Select all of the objects in the group (by tapping) | 1 |
| Group | | |
| Select | Use 1-3 fingers to hold an object in the group while | 2 |
| Group | using 1-3 fingers from other hand to tap each | |
| | additional object in sequence. | |
| Shrink | Use thumb + index finger, spread apart and pinching | 1 |
| | together, on top of object | |
| Shrink | Use all five fingers spread out radially, and bring | 1 |
| | them together, on top of object | |
| Shrink | Use 1-3 fingers from each hand, on object but | 2 |
| | spread apart, and bring them together | |
| Shrink | Use entire hands (palms, all 5 fingers, or edges), on | 2 |
| | object but spread apart, and bring them together | |
| Undo | Use 1-3 fingers to move in a zig-zagging/scribble | 1 |
| | motion on the background | |
| Zoom In | Enlarge motion performed on the background | 2 |
| | instead of on an object (pull apart with hands) | |
| Zoom In | Enlarge motion performed on the background | 2 |
| | instead of on an object (spread apart with fingers) | |
| Zoom In | Enlarge motion performed on the background | 1 |
| | instead of on an object (reverse pinch) | |
| Zoom In | Enlarge motion performed on the background | 1 |
| | instead of on an object (splay) | |
| Zoom Out | Shrink motion performed on the background instead | 2 |
| | of on an object (squish with hands) | |
| Zoom Out | Shrink motion performed on the background instead | 2 |
| | of on an object (pinch with 2 hands' fingers) | |
| Zoom Out | Shrink motion performed on the background instead | 1 |
| | of on an object (pinch) | |
| Zoom Out | Shrink motion performed on the background instead | 1 |
| | of on an object (reverse splay) | |
| Accept | Widget (button) | 1 |
| Close | Widget (close box/button/icon) | 1 |
| Delete | Move target object to on-screen trashcan icon/area | 1 |
| Help | Widget (button/menu) | 1 |
| Insert | Move target object to insertion point OR Paste target | 1 |
| | object at insertion point (physics will move any | |
| | blocking objects out of the way) | |
| Insert | Move blocking objects out of the way then either | 1 or 2 |
| | Move target object to insertion point or Paste target | |
| | object at insertion point | |
| Maximize | Enlarge object (object snaps to maximized state | 1 or 2 |
| | when enlarged out to screen edges) | |

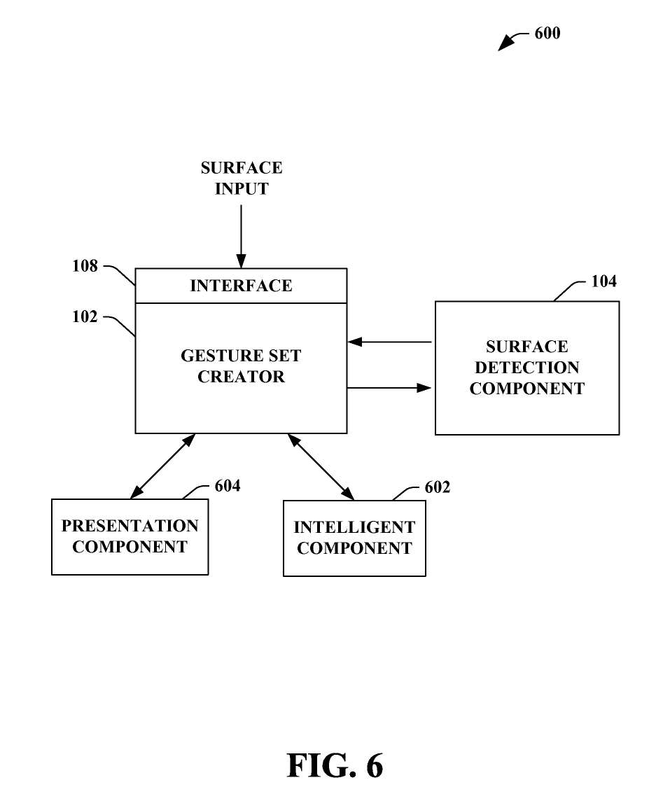

FIG. 6 illustrates a system 600 that employs intelligence to facilitate automatically identifies correlations between various surface inputs from disparate users in order to create a user-defined gesture set. The system 600 can include the gesture set creator 102, the surface detection component 104, the surface input, and/or the interface 108, which can be substantially similar to respective components, interfaces, and surface inputs described in previous figures. The system 600 further includes an intelligent component 602. The intelligent component 602 can be utilized by the gesture set creator 102 to facilitate data interaction in connection with surface computing. For example, the intelligent component 602 can infer gestures, surface input, prompts, tutorials, personal settings, user preferences, surface detection techniques, user intentions for surface inputs, referents, etc.

The intelligent component 602 can employ value of information (VOI) computation in order to identify a user-defined gesture based on received surface inputs. For instance, by utilizing VOI computation, the most ideal and/or appropriate user-defined gesture to relate to a detected input (e.g., surface input, etc.) can be identified. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The gesture set creator 102 can further utilize a presentation component 604 that provides various types of user interfaces to facilitate interaction between a user and any component coupled to the gesture set creator 102. As depicted, the presentation component 604 is a separate entity that can be utilized with the gesture set creator 102. However, it is to be appreciated that the presentation component 604 and/or similar view components can be incorporated into the gesture set creator 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the gesture set creator 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering information. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

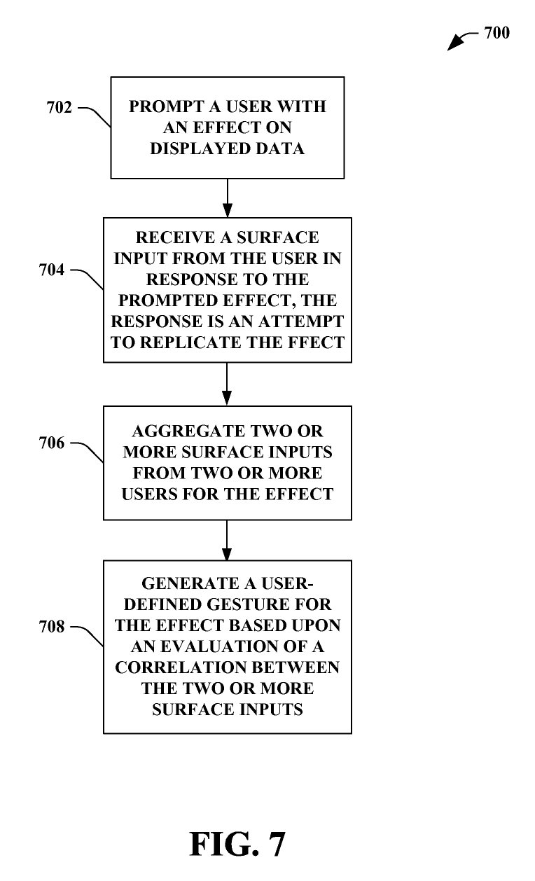

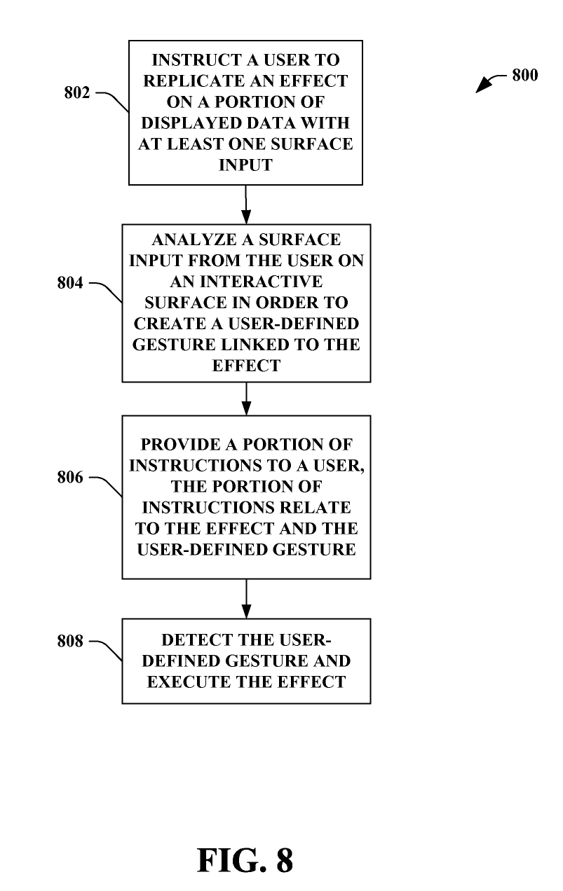

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates collecting surface input data in order to generate a user-defined gesture set. At reference numeral 702, a user can be prompted with an effect on displayed data. For example, the prompt can be instructions that the user is to attempt to replicate the effect on displayed data via a surface input and surface computing system/component. At reference numeral 704, a surface input can be received from the user in response to the prompted effect, wherein the response is an attempt to replicate the effect. For example, the effect can be, but is not limited to, data selection, data set or group selection, data move, data pan, data rotate, data cut, data paste, data duplicate, data delete, accept, help, reject, menu, undo, data enlarge, data shrink, zoom in, zoom out, open, minimize, next, previous, etc.

At reference numeral 706, two or more surface inputs from two or more users can be aggregated for the effect. In general, any suitable number of users can be prompted and tracked in order to collect surface input data. At reference numeral 708, a user-defined gesture can be generated for the effect based upon an evaluation of a correlation between the two or more surface inputs. In other words, a user-defined gesture can be identified based upon a correlation between two or more users providing correlating surface input data in response to the effect. The user-defined gesture can be utilized in order to execute the effect on a portion of displayed data. For example, an effect such as moving data can be prompted in order to receive a user's surface input (e.g., a dragging motion on the data), wherein such data can be evaluated with disparate users in order to identify a universal user-defined gesture.

FIG. 8 illustrates a method 800 for creating and utilizing a user-defined gesture set in connection with surface computing. At reference numeral 802, a user can be instructed to replicate an effect on a portion of displayed data with at least one surface input. It is to be appreciated that surface inputs can be, but are not limited to being, touch events, inputs, contacts, gestures, hand-motions, hand interactions, object interactions, and/or any other suitable interaction with a portion of displayed data.

At reference numeral 804, a surface input can be analyzed from the user on an interactive surface in order to cerate a user-defined gesture linked to the effect. For example, the user-defined gesture can be, but is not limited to being, a first select single gesture, a second select single gesture, a select group gesture, a first move gesture, a second move gesture, a pan gesture, a cut gesture, a first paste gesture, a second paste gesture, a rotate gesture, a duplicate gesture, a delete gesture, an accept gesture, a reject gesture, a help gesture, a menu gesture, an undo gesture, a first enlarge/shrink gesture, a second enlarge/shrink gesture, a third enlarge/shrink gesture, a fourth enlarge/shrink gesture, an open gesture, a zoom in/out gesture, a minimize gesture, a next/previous gesture, etc.

At reference numeral 806, a portion of instructions can be provided to a user, wherein the portion of instructions can relate to the effect and the user-defined gesture. For example, the portion of instructions can provide a concise explanation of the user-defined gesture and/or an effect on displayed data. At reference numeral 808, the user-defined gesture can be detected and the effect can be executed.

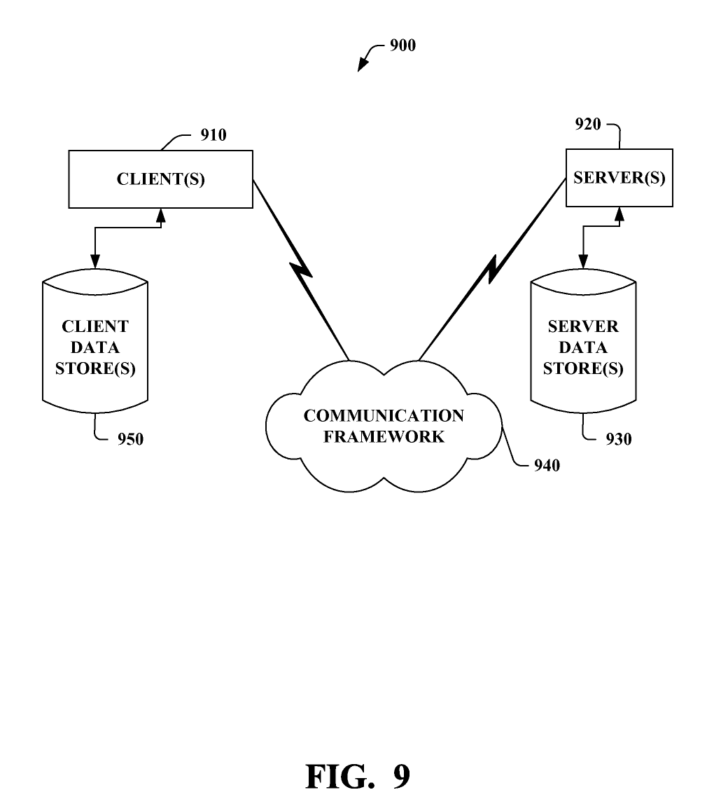

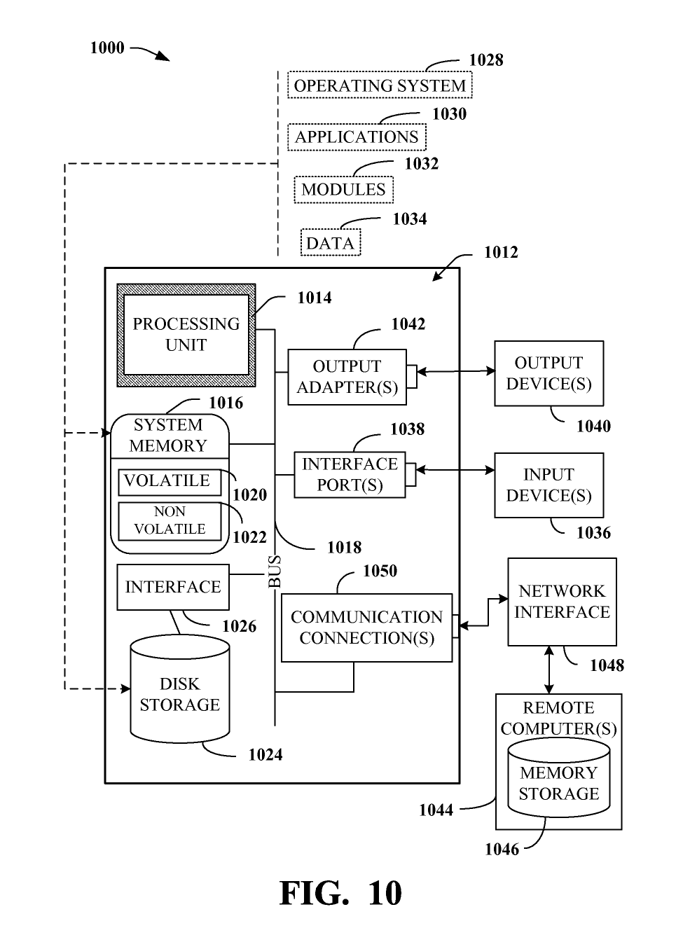

In order to provide additional context for implementing various aspects of the claimed subject matter, FIGS. 9-10 and the following discussion is intended to provide a brief, general description of a suitable computing environment in which the various aspects of the subject innovation may be implemented. For example, a gesture set creator that evaluates user surface input in response to a communicated effect for generation of a user-defined gesture set, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates generating an intuitive set of gestures for employment with computing, comprising:
a gesture set creator that prompts two or more users with a potential effect for a portion of displayed data;
an interface component that receives at least one hand motion from the user in response to the prompted potential effect, the hand motion is an attempted replication of the potential effect;
a vision-based detection component that tracks the hand motion;
the gesture set creator collects the hand motion from the two or more users; and
an intelligent component that forms an inference to identify a user-defined gesture in a data store based upon a correlation between the respective hand motions,
wherein the user-defined gesture is defined as an input that initiates the potential effect for the portion of displayed data.

2. The system of claim 1, wherein the hand motion is a hand gesture, a gesture, a hand interaction, an object interaction, a portion of a hand interacting with a surface, or a corporeal object.

3. The system of claim 1, wherein the potential effect is at least one of a data selection, a data set selection, a group selection, a data move, a data pan, a data rotate, a data cut, a data paste, a data duplicate, a data delete, an accept, a help request, a reject, a menu request, an undo, a data enlarge, a data shrink, a zoom in, a zoom out, an open, a minimize, a next, or a previous.

4. The system of claim 1, wherein the vision based detection component detects the user-defined gesture which executes the potential effect for the portion of displayed data.

5. The system of claim 1, wherein the potential effect is communicated to the user as at least one of a portion of verbal instruction, a portion of video, a portion of audio, a portion of text, or a portion of a graphic.

6. The system of claim 1, further comprising two or more user-defined gestures that are a user-defined gesture set, the user-defined gesture set includes a first select single gesture, a second select single gesture, a select group gesture, a first move gesture, a second move gesture, a pan gesture, a cut gesture, a first paste gesture, a second paste gesture, a rotate gesture, a duplicate gesture, a delete gesture, an accept gesture, a reject gesture, a help gesture, a menu gesture, an undo gesture, a first enlarge/shrink gesture, a second enlarge/shrink gesture, a third enlarge/shrink gesture, a fourth enlarge/shrink gesture, an open gesture, a zoom in/out gesture, a minimize gesture, and a next/previous gesture.

7. The system of claim 1, further comprising a tutorial component that provides a portion of instruction in relation to at least one user-defined gesture.

8. The system of claim 6, wherein the gesture set creator provides a periodic adjustment to the generated user-defined gesture set based at least in part upon historic data collection.

9. The system of claim 1, wherein the inference identifies the most ideal or appropriate user-defined gesture from the hand motion.

10. The system of claim 1, wherein the intelligent component forms the inference with an explicitly and/or implicitly trained schemes including a support vector machine, a neural network, an expert system, a Bayesian belief network, fuzzy logic, or a data fusion engine.

11. A method that facilitates generating an intuitive set of gestures for employment with computing, comprising:
prompting two or more users with a potential effect for a portion of displayed data;
receiving at least one hand motion from the user in response to the prompted potential effect, the hand motion is an attempted replication of the potential effect;
tracking the hand motion with a vision-based detector;
collecting the hand motion from the two or more users; and
forming an inference to identify a user-defined gesture in a data store based upon a correlation between the respective hand motions,
wherein the user-defined gesture is defined as an input that initiates the potential effect for the portion of displayed data.

12. The method of claim 11, wherein the hand motion is a hand gesture, a gesture, a hand interaction, an object interaction, a portion of a hand interacting with a surface, or a corporeal object.

13. The method of claim 11, wherein the potential effect is at least one of a data selection, a data set selection, a group selection, a data move, a data pan, a data rotate, a data cut, a data paste, a data duplicate, a data delete, an accept, a help request, a reject, a menu request, an undo, a data enlarge, a data shrink, a zoom in, a zoom out, an open, a minimize, a next, or a previous.

14. The method of claim 11, further comprising executing the potential effect for the portion of displayed data.

15. The method of claim 11, further comprising communicating the potential effect to the user as at least one of a portion of verbal instruction, a portion of video, a portion of audio, a portion of text, or a portion of a graphic.

16. The method of claim 11, further comprising two or more user-defined gestures that are a user-defined gesture set, the user-defined gesture set includes a first select single gesture, a second select single gesture, a select group gesture, a first move gesture, a second move gesture, a pan gesture, a cut gesture, a first paste gesture, a second paste gesture, a rotate gesture, a duplicate gesture, a delete gesture, an accept gesture, a reject gesture, a help gesture, a menu gesture, an undo gesture, a first enlarge/shrink gesture, a second enlarge/shrink gesture, a third enlarge/shrink gesture, a fourth enlarge/shrink gesture, an open gesture, a zoom in/out gesture, a minimize gesture, and a next/previous gesture.

17. The method of claim 11, further comprising providing a portion of instruction in relation to at least one user-defined gesture.

18. The method of claim 16, further comprising providing a periodic adjustment to the generated user-defined gesture set based at least in part upon historic data collection.

19. The method of claim 11, wherein forming an inference further comprises identifying the most ideal or appropriate user-defined gesture from the hand motion.

20. The method of claim 11, wherein forming an inference further comprises using an explicitly and/or implicitly trained schemes including a support vector machine, a neural network, an expert system, a Bayesian belief network, fuzzy logic, or a data fusion engine.

21. A computer-implemented system that facilitates an intuitive set of gestures for employment with surface computing, comprising:
means for prompting two or more users with a potential effect for a portion of displayed data;
means for receiving at least one hand motion from the user in response to the prompted potential effect, the hand motion is an attempted replication of the potential effect;
means for tracking the hand motion with a vision-based detector;
means for collecting the hand motion from the two or more users; and
means for forming an inference to identify a user-defined gesture in a data store based upon a correlation between the respective hand motions,
wherein the user-defined gesture is defined as an input that initiates the potential effect for the portion of displayed data.
means for receiving at least one surface input from a user directed to a portion of displayed data;
means for tracking the surface input;
means for collecting the surface input from the user in order to identify a user-defined gesture within a user-defined gesture set, the user-defined gesture set includes a first select single gesture, a second select single gesture, a select group gesture, a first move gesture, a second move gesture, a pan gesture, a cut gesture, a first paste gesture, a second paste gesture, a rotate gesture, a duplicate gesture, a delete gesture, an accept gesture, a reject gesture, a help gesture, a menu gesture, an undo gesture, a first enlarge/shrink gesture, a second enlarge/shrink gesture, a third enlarge/shrink gesture, a fourth enlarge/shrink gesture, an open gesture, a zoom in/out gesture, a minimize gesture, and a next/previous gesture; and
means for executing a potential effect for the portion of display triggered by the identified user-defined gesture.

22. The computer-implemented system of claim 21, wherein the hand motion is a hand gesture, a gesture, a hand interaction, an object interaction, a portion of a hand interacting with a surface, or a corporeal object.

23. The computer-implemented system of claim 21, wherein the potential effect is at least one of a data selection, a data set selection, a group selection, a data move, a data pan, a data rotate, a data cut, a data paste, a data duplicate, a data delete, an accept, a help request, a reject, a menu request, an undo, a data enlarge, a data shrink, a zoom in, a zoom out, an open, a minimize, a next, or a previous.

24. The computer-implemented system of claim 21, further comprising means for executing the potential effect for the portion of displayed data.

25. The computer-implemented system of claim 21, further comprising means for communicating the potential effect to the user as at least one of a portion of verbal instruction, a portion of video, a portion of audio, a portion of text, or a portion of a graphic.

26. The computer-implemented system of claim 21, further comprising two or more user-defined gestures that are a user-defined gesture set, the user-defined gesture set includes a first select single gesture, a second select single gesture, a select group gesture, a first move gesture, a second move gesture, a pan gesture, a cut gesture, a first paste gesture, a second paste gesture, a rotate gesture, a duplicate gesture, a delete gesture, an accept gesture, a reject gesture, a help gesture, a menu gesture, an undo gesture, a first enlarge/shrink gesture, a second enlarge/shrink gesture, a third enlarge/shrink gesture, a fourth enlarge/shrink gesture, an open gesture, a zoom in/out gesture, a minimize gesture, and a next/previous gesture.

27. The computer-implemented system of claim 21, further comprising means for providing a portion of instruction in relation to at least one user-defined gesture.

28. The computer-implemented system of claim 26, further comprising means for providing a periodic adjustment to the generated user-defined gesture set based at least in part upon historic data collection.

29. The computer-implemented system of claim 21, wherein the means for forming an inference further comprises means for identifying the most ideal or appropriate user-defined gesture from the hand motion.

30. The computer-implemented system of claim 21, wherein the means for forming an inference further comprises means for using an explicitly and/or implicitly trained schemes including a support vector machine, a neural network, an expert system, a Bayesian belief network, fuzzy logic, or a data fusion engine.
